(19) United States
(12) Patent Application Publication
(10) Pub. No.: US 2026/0353047 A1
(43) Pub. Date: Nov. 5, 2026

(54) SENSING SYSTEM AND METHOD FOR INTEGRATED COMMUNICATION

(71) Applicant: JIO PLATFORMS LIMITED, Ahmedabad (IN)

(72) Inventors: Satish JAMADAGNI, Bangalore (IN); Vinay Kumar SHRIVASTAVA, Bangalore (IN); Pradeep HIRISAVE, Bengaluru (IN); Mathew OOMMEN, Plano, TX (US)

(73) Assignee: JIO PLATFORMS LIMITED, Ahmedabad (IN)

(21) Appl. No.: 19/485,061

(22) PCT Filed: May 22, 2024
(86) PCT No.: PCT/IB2024/054966

§ 371 Date: Nov. 17, 2025

(30) Foreign Application Priority Data
May 30, 2023 (IN) 202321037375

(51) Int. Cl. H04W 4/38; H04B 7/06; H04W 76/10; H04W 76/20

(52) U.S. Cl. CPC H04W 4/38; H04B 7/0626; H04W 76/10; H04W 76/20

(57) ABSTRACT

The present disclosure relates to a system (108) and a method for sharing sensing data in a cellular network (106). The system (108) establishes a Radio Resource Control (RRC) connection between sensing clients (104) and sensing agents (110). Upon successful establishment of the RRC connection, the system (108) determines that an aggregation type flag indicating an aggregation is enabled in a sensing aggregation entity (112) associated with the system (108). The sensing aggregation entity (112) to receive a sensing data report from each of the sensing agents (110), and facilitate aggregation of the sensing data report received from each of the sensing agents (110) in the sensing aggregation entity (112) according to service requirements. Further, the system (108) transmits a response message to the sensing clients (104) in response to the aggregation of the sensing data report.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The embodiments of the present disclosure generally relate to communication networks. In particular, the present disclosure relates to communication networks with integrated sensing and communication capabilities.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

5^{th} Generation (5G) wireless technology developed in Third Generation Partnership Project (3GPP) is meant to deliver higher multi-Gbps peak data speeds, ultra-low latency, more reliability, massive network capacity, increased availability, and a more uniform user experience to multiple users. Higher performance and improved efficiency empower new user experiences and connects new industries. However, while some of the objectives have been met, but there are still quite a few issues that need to be resolved especially when it comes to accommodating industry verticals, architectures to support private networks, and support flexible network deployments, etc.

6^{th} Generation (6G) networks have been proposed as a solution. However, existing solutions do not accommodate multiple physical layers concepts such as Orthogonal Time Frequency Space (OFTS), Full Duplex, availability of intelligent surface, and appropriate upper/higher level considerations. Further, existing 6G network solutions do not adequately expand the human experience across physical, biological, and digital worlds while at the same time enabling next-generation industrial operations environment beyond Industry 4.0 in dimensions of performance such as positioning, sensing, ultra-reliability, energy efficiency, and extreme real-time. Further, existing 6G networks solutions do not provide novel radio and access architecture for both communications and sensing purposes, artificial intelligences (AI) optimized wide area networks, and data centres co-design, as well as dynamic orchestration of personalized services to revolutionize a long tail of niche consumer interests.

Moreover, existing solutions do not utilize a full potential of existing architecture of transmit/receive (Tx/Rx) nodes, thereby limiting a number of use cases available, where services involving sensing capabilities such as spatial sensing to users or applications that are external to the network. Utilizing the existing infrastructure to the fullest may allow for providing full area coverage as well as a good interconnection between nodes, which facilitates a multi-static sensory mesh.

With the evolution from 4G to 5G, spectrum allocations have been expanded towards higher frequencies. This trend may continue and communication spectra in a sub-Terahertz region may likely be available as some of the frequency bands for 6G deployments. With the introduction of these new frequencies, the potential for very accurate sensing based on radar-like technology arises. That is, reflections of transmitted signals are received in the network and processed to yield spatial knowledge of the physical surroundings. Sensing as an integrated capability is of interest throughout the frequency range used by mobile communication networks, starting as low as 700 MHz, where the lowest time-division duplex (TDD) bands are located. Such developments may cause the need for solutions that utilize the enhanced capabilities of such networks.

Furthermore, communication networks may employ beamforming of the transmitted signals to concentrate and direct the signal energy to a specific geographical area where an intended receiver is located at the aforementioned frequencies. An inter-site distance (ISD) necessary to create full geographical coverage without beamforming may be prohibitively short.

There is, therefore, a need for improved systems and methods for supporting a combined communication and sensing radio network by overcoming the deficiencies in the prior art(s).

### OBJECTS OF THE PRESENT DISCLOSURE

Some of the objects of the present disclosure, which at least one embodiment herein satisfy are as listed herein below.

An object of the present disclosure is to provide a system and a method that supports both communication and sensing capabilities in a cellular network.

Another object of the present disclosure is to provide an integrated communication and sensing system and method with improved performance.

Another object of the present disclosure is to provide an integrated communication and sensing system and method with outdoor spatial sensing as a service to users external to a network.

Another object of the present disclosure is to provide an integrated communication and sensing system and method with indoor sensing for applications including, but not limited to, manufacturing facilities.

Another object of the present disclosure is to provide an integrated communication and sensing system and method with sensing to aid simulations of digital twins of structures.

Another object of the present disclosure is to provide an integrated communication and sensing system and method with sensing to provide automotive manoeuvring and navigation.

Another object of the present disclosure is to provide an advanced communication system.

Another object of the present disclosure is to provide a coreless network deployment in which a sensing aggregation entity and a possible application level sensing agent are resident at a Radio Access Network (RAN) entity in 6G or beyond networks.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for sharing sensing data in a cellular network. The system includes a processor, and a memory operatively coupled with the processor. The memory stores instructions which, when executed by the processor, cause the processor to establish a Radio Resource Control (RRC) connection between one or more sensing clients and a plurality of sensing agents. Upon successful establishment of the RRC connection, the processor determines that an aggregation type flag indicating an aggregation is enabled in a sensing aggregation entity associated with the system. The processor enables the sensing aggregation entity to receive a sensing data report from each of the plurality of sensing agents based on the determination, where each of the plurality of sensing agents receives the sensing data report from the one or more sensing clients. The processor facilitates aggregation of the sensing data report received from each of the plurality of sensing agents in the sensing aggregation entity according to service requirements, and transmits a response message to the one or more sensing clients in response to the aggregation of the sensing data report.

In an embodiment, the processor may receive the sensing data report from each of the plurality of sensing agents, and transmit the response message to the one or more sensing clients as at least one message, where the at least one message may be one of a Non-Access Stratum (NAS) message or a broadcast message.

In an embodiment, the sensing data report may include a plurality of attributes. The plurality of attributes may include at least one of a target location, a direction indication, a signal quality, Channel State Information (CSI), beamforming parameters, an interference level, bandwidth allocation, a Doppler shift, a carrier frequency, time synchronization, environmental sensing parameters, energy efficiency, security parameters, mobility management, latency and delay, and a traffic load.

In an embodiment, the processor may enable each of the plurality of sensing agents to receive the sensing data report from the one or more sensing clients upon structuring the sensing data report according to a predefined list of sensing data.

In an embodiment, the processor may enable the sensing aggregation entity to receive the sensing data report from each of the plurality of sensing agents by being configured to receive a data aggregation request from each of the plurality of sensing agents.

In an embodiment, in response to transmitting the response message to the one or more sensing clients, the processor may release the RRC connection between the one or more sensing clients and the plurality of sensing agents.

In an aspect, the present disclosure relates to a method for sharing sensing data in a cellular network. The method includes establishing, by a processor associated with a system, a RRC connection between one or more sensing clients and a plurality of sensing agents. Upon successful establishment of the RRC connection, the method includes determining, by the processor, that an aggregation type flag indicating an aggregation is enabled in a sensing aggregation entity associated with the system. The method includes enabling, by the processor, the sensing aggregation entity to receive a sensing data report from each of the plurality of sensing agents based on the determination, where each of the plurality of sensing agents may receive the sensing data report from the one or more sensing clients. The method includes facilitating, by the processor, aggregation of the sensing data report received from each of the plurality of sensing agents in the sensing aggregation entity according to service requirements, and transmitting, by the processor, a response message to the one or more sensing clients in response to the aggregation of the sensing data report.

In an embodiment, the method may include receiving, by the processor, the sensing data report from each of the plurality of sensing agents, and transmitting, by the processor, the response message to the one or more sensing clients as at least one message. The at least one message may be one of a NAS message or a broadcast message.

In an embodiment, the sensing data report may include a plurality of attributes. The plurality of attributes may be at least one of a target location, a direction indication, a signal quality, CSI, beamforming parameters, an interference level, bandwidth allocation, a Doppler shift, a carrier frequency, time synchronization, environmental sensing parameters, energy efficiency, security parameters, mobility management, latency and delay, and a traffic load.

In an embodiment, the method may include enabling, by the processor, each of the plurality of sensing agents to receive the sensing data report from the one or more sensing clients upon structuring the sensing data report according to a predefined list of sensing data.

In an embodiment, the method may include enabling, by the processor, the sensing aggregation entity to receive the sensing data report from each of the plurality of sensing agents comprises receiving, by the processor, a data aggregation request from each of the plurality of sensing agents.

In an embodiment, in response to transmitting the response message to the one or more sensing clients, the method may include releasing, by the processor, the RRC connection between the one or more sensing clients and the plurality of sensing agents.

In an aspect, the present disclosure relates to a user equipment (UE) including a processor and a memory operatively coupled to the processor. The memory includes processor-executable instructions, which on execution, cause the processor to establish a RRC connection with a plurality of sensing agents associated with a system, and upon successful establishment of the RRC connection, transmit a sensing data report to each of the plurality of sensing agents. The processor is communicatively coupled with the system, and the system is configured to determine that an aggregation type flag indicating an aggregation is enabled in a sensing aggregation entity associated with the system. The system is configured to enable the sensing aggregation entity to receive the sensing data report from each of the plurality of sensing agents based on the determination. The system is configured to facilitate aggregation of the sensing data report received from each of the plurality of sensing agents in the sensing aggregation entity according to service requirements, and transmit a response message to the UE in response to the aggregation of the sensing data report.

In an aspect, the present disclosure relates to a non-transitory computer-readable medium comprising processor-executable instructions that cause a processor to establish a RRC connection between one or more sensing clients and a plurality of sensing agents. Upon successful establishment of the RRC connection, the processor determines that an aggregation type flag indicating an aggregation is enabled in a sensing aggregation entity associated with the system. The processor enables the sensing aggregation entity to receive a sensing data report from each of the plurality of sensing agents based on the determination, where each of the plurality of sensing agents receives the sensing data report from the one or more sensing clients. The processor facilitates aggregation of the sensing data report received from each of the plurality of sensing agents in the sensing aggregation entity according to service requirements. The processor transmits a response message to the one or more sensing clients in response to the aggregation of the sensing data report.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that the invention of such drawings includes the invention of electrical components, electronic components, or circuitry commonly used to implement such components.

FIG. 1 illustrates an exemplary network architecture 100 for implementing a proposed system, in accordance with an embodiment of the present disclosure.

FIG. 2 illustrates an example block diagram 200 of a proposed system, in accordance with an embodiment of the present disclosure.

FIGS. 3A-3B illustrate exemplary architectures 300A, 300B in which or with which a proposed system of the present disclosure may be implemented, in accordance with embodiments of the present disclosure.

FIGS. 4A-4B illustrate exemplary sequence diagrams 400A, 400B for implementing an interface between a sensing client and a sensing aggregation (SA) entity via a sensing agent, in accordance with an embodiment of the present disclosure.

FIG. 5 illustrates an exemplary sequence diagram 500 for implementing a method for sharing sensing data in a cellular network, in accordance with an embodiment of the present disclosure.

FIG. 6 illustrates an example flowchart 600 illustrating a scenario for sensing objects at a pedestrian crossing, in accordance with the embodiments of the present disclosure.

FIGS. 7A-7D illustrate exemplary applications 700A-700D of the proposed system, in accordance with embodiments of the present disclosure.

FIG. 8 illustrates an exemplary computer system 800 in which or with which embodiments of the present disclosure can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In an aspect, the present disclosure provides a system and a method to accommodate, collect, and share sensing data in a cellular network. The system may include sensing clients, sensing agents, and entities that can handle and process new sensor data in a cellular system. In an aspect, additional entities and mechanisms may be introduced for fusing multiple sensory data and the mechanism of conveying such data to an end user. The system may also enable provision of sensing data as a service.

In another aspect, the sensing data may be used for identification of objects, static or in motion, a number of people entering or exiting from buildings, and a type of objects/entities that enter or exit from the buildings/shops, the traffic density sensing in a road, people density in buildings or roads, identification of pets, etc.

In an aspect, the integrated communication and sensing system and method may include a sensing aggregation entity that receives requests for sensing and location at a Radio Access Network (RAN) node. The sensing aggregation entity may act as a data fusion entity at the RAN node. The RAN node may have a capability to sense objects via a combined sensing/communication multiple-input and multiple-output (MIMO) panels or via separate communication and sensing units that may be configured on an antenna tower associated with the RAN node. The architecture may identify a sensing agent (indicative of actual sensors) which interfaces with the sensing client or a User Equipment (UE), the RAN node, and a core network via newly defined interfaces.

In another aspect, the integrated network may also include one or more sensor aggregation (SA) entities. At least one of the SA entities may be configured to each of the RAN node and the core network. The RAN node may receive, and if needed, aggregate the multi sensor/location data sensed or measured. Further, sensing data may also be shared by the sensors or sensing agents to the SA entities. The interface between the sensing agent and the SA entities may be defined as part of the embodiments. The interface between an Evolved Serving Mobile Location Center (E-SMLC), a Location Management Function (LMF), a Serving Location Protocol (SLP), and the SA entities may also be defined as part of the disclosure. Any request for sensing/location may also indicate if the service needs to be serviced individually or in a data fused manner. The sensing agent may reside at the UE/device itself, or at a base station (eNB, gNB, etc.), or at the application level.

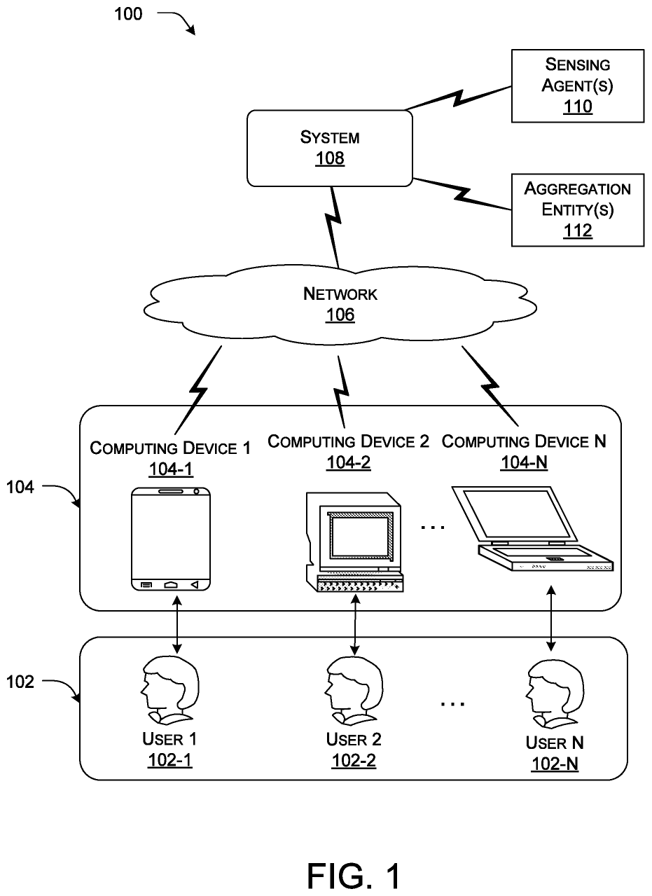

Various embodiments of the present disclosure will be explained in detail with reference to FIGS. 1-8.

FIG. 1 illustrates an exemplary network architecture 100 for implementing a proposed system, in accordance with an embodiment of the present disclosure.

As illustrated in FIG. 1, by way of example and not by not limitation, the exemplary network architecture (100) may include one or more sensing clients. The one or more sensing clients may be, for example, a plurality of computing devices (104-1, 104-2 . . . 104-N), which may be individually referred as the computing device (104) and collectively referred as the computing devices (104). It may be appreciated that the computing device (104) may be interchangeably referred to as the sensing client or a user equipment. The plurality of computing devices (104) may include, but not be limited to, scanners such as cameras, webcams, scanning units, and the like.

In an embodiment, the computing device (104) may include smart devices operating in a smart environment, for example, an Internet of Things (IoT) system. In such an embodiment, the computing device (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the computing device, the sensing client, or the user equipment (104) may include, but is not limited to, intelligent, multi-sensing, network-connected devices, that can integrate seamlessly with each other and/or with a central server or a cloud-computing system or any other device that is network-connected.

In an embodiment, the user device or the user equipment (104) may include, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electromechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user or the entity such as a touch pad, a touch enabled screen, an electronic pen, and the like. A person of ordinary skill in the art will appreciate that the user equipment (104) may not be restricted to the mentioned devices and various other devices may be used.

In an exemplary embodiment, the user equipment (104) may communicate with a system (108), for example, an integrated communication and sensing system through a network (106). The user equipment (104) may establish a Radio Resource Control (RRC) connection with a plurality of sensing agents (110) associated with the system (108). The plurality of sensing agents (110) may be individually referred as the sensing agent (110) and collectively referred as the sensing agents (110). The sensing agents (110) may reside at the user equipment (104)/device itself, or at a base station (eNB, gNB, etc.,), or at an application level. Upon successful establishment of the RRC connection, the user equipment (104) may transmit a sensing data report to each of the sensing agents (110) via the network (106).

The network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may include, by way of example but not limitation, one or more of a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

Further, the system (108) may be associated with one or more aggregation entities (112). It may be appreciated that the aggregation entities (112) may be interchangeably referred to as sensing aggregation entities or data fusion entities.

In an exemplary embodiment, the system (108) may be configured to determine that an aggregation type flag indicating an aggregation is enabled in the sensing aggregation entity (112) upon successful establishment of the RRC connection between the user equipment (104) (sensing clients) and the sensing agents (110). In an embodiment, the system (108) may be configured to enable the sensing aggregation entity (112) to receive a data aggregation request from each of the plurality of sensing agents. In an embodiment, the system (108) may be configured to enable the sensing aggregation entity (112) to receive the sensing data report from each of the sensing agents (110) based on the request when the aggregation type flag indicating the aggregation is enabled in the sensing aggregation entity (112). The sensing data report may be structured according to a predefined list of sensing data.

The sensing data report may include a plurality of attributes. The plurality of attributes may include, but not limited to, a target location, a direction indication, a signal quality, Channel State Information (CSI), beamforming parameters, an interference level, bandwidth allocation, a Doppler shift, a carrier frequency, time synchronization, environmental sensing parameters, energy efficiency, security parameters, mobility management, latency and delay, and a traffic load. The sensing data report may be received and transmitted as a message which may be, for example, a Non-Access Stratum (NAS) message or a broadcast message.

In an embodiment, the system (108) may be configured to facilitate aggregation of the sensing data report received from each of the plurality of sensing agents (110) in the sensing aggregation entity (112) according to service requirements. Upon aggregating the sensing data reports, the system (108) may be configured to transmit a response message to the user equipment (104) (sensing clients). In response to transmitting the response message to the user equipment (104) (sensing clients), the system (108) may release the RRC connection between the user equipment (104) (sensing clients) and the sensing agents (110).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

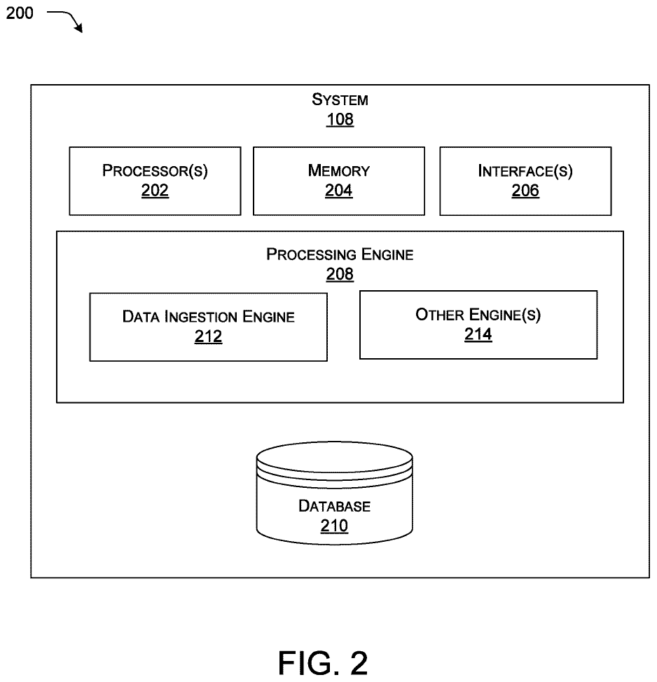

FIG. 2 illustrates an example block diagram 200 of a proposed system, in accordance with an embodiment of the present disclosure.

In an embodiment, and as shown in FIG. 2, the system (108) may include one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204) of the system (108). The memory (204) may store one or more computer-readable instructions or routines, which may be fetched and executed to create or share the data units over a network service. The memory (204) may comprise any non-transitory storage device including, for example, volatile memory such as a Random-Access Memory (RAM), or a non-volatile memory such as an Erasable Programmable Read-Only Memory (EPROM), a flash memory, and the like.

In an embodiment, the system (108) may also include an interface(s) (206). The interface(s) (206) may include a variety of interfaces, for example, interfaces for data input and output devices, referred to as I/O devices, storage devices, and the like. The interface(s) (206) may facilitate communication of the system (108) with various devices coupled to it. The interface(s) (206) may also provide a communication pathway for one or more components of the system (108). Examples of such components include, but are not limited to, processing engine(s) (208) and a database (210).

In an embodiment, the processing engine(s) (208) may be implemented as a combination of hardware and programming (for example, programmable instructions) to implement one or more functionalities of the processing engine(s) (208). In examples, described herein, such combinations of hardware and programming may be implemented in several different ways. For example, the programming for the processing engine(s) (208) may be processor-executable instructions stored on a non-transitory machine-readable storage medium and the hardware for the one or more processors (202) may include a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by an electronic circuitry.

In an embodiment, the database (210) may include data that may be either stored or generated as a result of functionalities implemented by any of the components of the processor(s) (202) or the processing engine(s) (208) or the system (108).

In an exemplary embodiment, the processing engine(s) (208) may include one or more engines selected from any of a data ingestion engine (212) and other units/engines (214). The other units/engines (214) may include, but are not limited to, a data acquisition engine, a monitoring engine, a notification engine, and the like.

In an embodiment, the processor (202) may, via the data ingestion engine (212), establish a RRC connection between sensing clients (e.g. user equipment) (104) and sensing agents (110). Upon successful establishment of the RRC connection, the processor (202) may, via the data ingestion engine (212), determine that an aggregation type flag indicating an aggregation is enabled in a sensing aggregation entity (112) associated with the system (108).

In an embodiment, the processor (202) may, via the data ingestion engine (212), enable the sensing aggregation entity (112) to receive a sensing data report from each of the sensing agents (110) when the aggregation type flag indicating the aggregation is enabled in the sensing aggregation entity (112). Each of the sensing agents (110) may receive the sensing data report from the sensing clients (104) via a network (106).

In an embodiment, the processor (202) may, via the data ingestion engine (212), facilitate aggregation of the sensing data report received from each of the sensing agents (110) in the sensing aggregation entity (112) according to service requirements. In an embodiment, the processor (202) may, via the data ingestion engine (212), transmit a response message to the sensing clients (104) in response to the aggregation of the sensing data report. In an embodiment, the processor (202) may, via the data ingestion engine (212), release the RRC connection between the sensing clients (104) and the sensing agents (110).

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

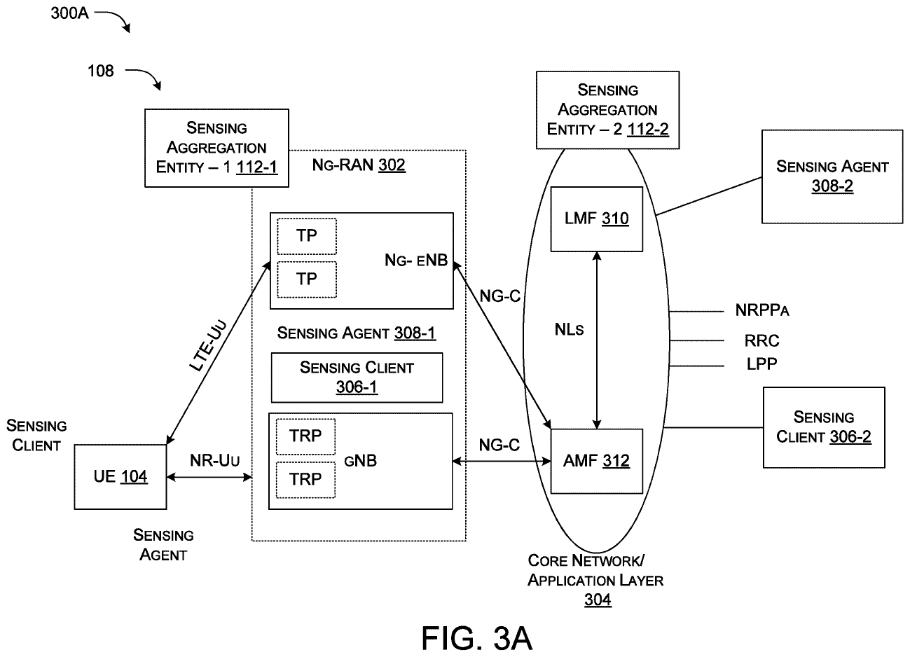

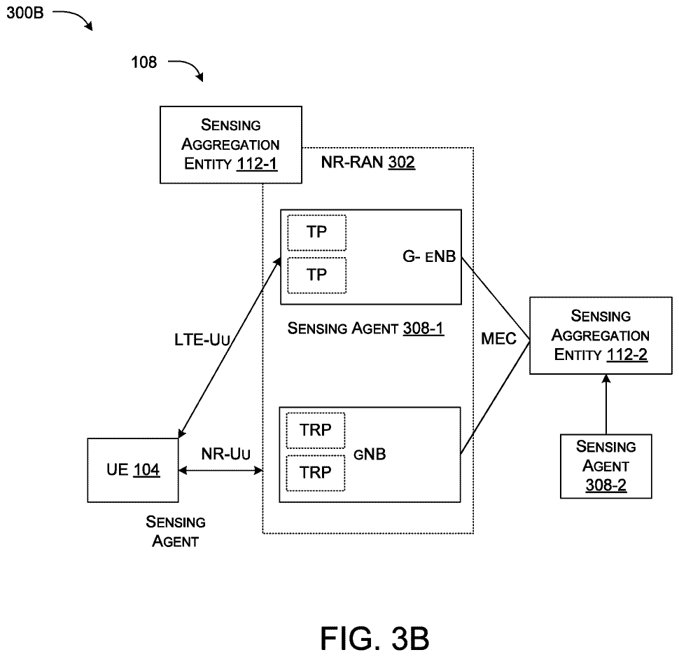

FIGS. 3A-3B illustrate exemplary architectures (300A, 300B) in which or with which a proposed system (108) of the present disclosure may be implemented, in accordance with embodiments of the present disclosure.

Referring to FIG. 3A, the system (108) may include one or more users (102) using a corresponding User Equipment (UE) (104). The one or more UEs (104) may be capable of communicating with one or more sensing aggregation entities (also referred to as SA entities (112)). In an embodiment, a first SA entity (112-1) may be coupled to a RAN node (302) or a New Generation Radio-Access Network (NG RAN) node having a base station indicative of Evolved NodeB (eNB) or Next Generation NodeB (gNB), or both.

In an embodiment, the system (108) may include a core network/application layer (304) that may be coupled to a second SA entity (112-2). The second SA entity (112-2) may include a LMF unit (310) and an Access and Mobility Management Function (AMF) unit (312). The UE (104), the RAN node (302), and the core network (304) may be coupled with a first sensing agent (308-1) and a first sensing client (306-1), a second sensing agent (308-2) and a second sensing client (306-2), and a third sensing agent (308-3) and a third sensing client (306-3), respectively. In an embodiment, the first, the second, and the third sensing agents (308) may be indicative of sensors capable of detecting sensing data.

In an embodiment, a communication network (e.g., network 106) for the one or more UEs (104) may include one or more RAN nodes (302) to facilitate communication therebetween. In an exemplary embodiment, the communication network may allow for communication between the one or more UEs (104), the RAN nodes (302), and the core network/application layer (304).

In an embodiment, the sensing agents (308) may include, but not be limited to, cameras, radio-frequency imaging devices, microphones, trans-receivers, and the like. In an embodiment, the sensing agents (308) may be configured to collect sensing data based on a request message provided by the UE (104). In an embodiment, the sensing data may include, but not be limited to, images, audio signals, radio frequency signals, and generally signals indicative of measurement of one or more predefined parameters. In an embodiment, the sensing agent (306) may be triggered to detect, collect, and transmit the sensing data on receiving the request message from any of the sensing clients (306).

In another embodiment, as shown in FIG. 3B, the system (108) may include the UE (104) and the RAN node (302). The said RAN node (302) may include the SA entity (112) coupled thereto. In such embodiments, a second sensing agent (308-2) associated with the core network (304) may be coupled to the RAN node (302).

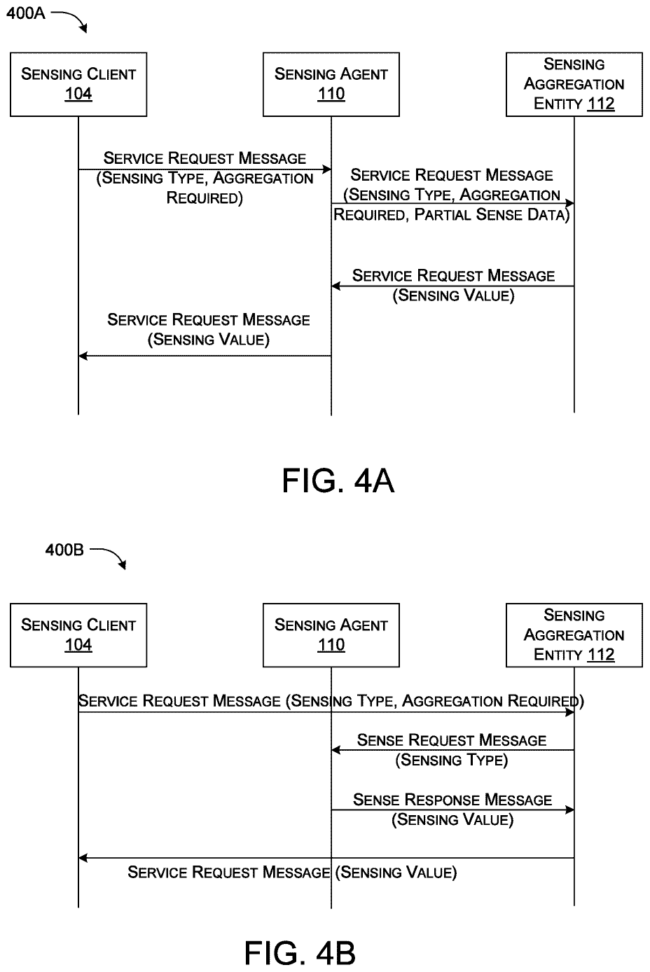

FIGS. 4A-4B illustrate exemplary sequence diagrams (400A, 400B) for implementing an interface between a sensing client and a SA entity via a sensing agent, in accordance with an embodiment of the present disclosure.

In an embodiment, a new set of messages may be defined between the sensing client (104) (e.g., UE), the sensing agent (110), and the SA entity (112), as illustrated in FIG. 1.

In an embodiment, as shown in FIG. 4A, the set of messages may be introduced between the sensing clients (104), the sensing agents (110), and the SA entity (112). In an exemplary embodiment, a service request message with one or more sensing type indication and an aggregation flag may be transmitted from the sensing clients (104) to the sensing agents (110). In an embodiment, the sensing agents (110) may process the service request message and add partial sensing information as per the capability of the sensing agent (110), and thereafter send the modified service request message to the SA entity (112).

In an embodiment, the sensing clients (104) may send the service request messages to the sensing agents (110) residing at the sensing clients (104) (e.g., UE). In an embodiment, the sensing clients (104) may send the service request messages to the sensing agents (110) residing at the RAN node (302). In an embodiment, the sensing clients (104) may send the service request messages to the sensing agents (110) residing at the core network/application level (304). In an embodiment, the sensing agents (110) may collect the sensing data requested in the request message, and also for any partial sensing information provided in the service request message by the sensing clients (104), thereby allowing the SA entity (112) to gather sensing data in a multi-level granularity. In an embodiment, the sensing data may also include the one or more sensing types and the aggregation flag. The sensing agent (110) may collect the sensing data based on the one or more sensing data types requested in the request message. In an embodiment, the sensing agent (110) may transmit the modified request message to the SA entity (112) based on the aggregation flag. In an embodiment, the SA entity (112) may process the sensed data received from the sensing agent (110). In an embodiment, the SA entity (112) may transmit the processed data in a response message to the sensing client (104).

In other embodiments, as shown in FIG. 4B, the service request message with the one or more sensing type indication and the aggregation flag may be transmitted from the sensing client (104) to the SA entity (112) directly. In such embodiments, the SA entity (112) may send a request to the sensing agent (110) for obtaining the appropriate sensing data and thereafter respond to the sensing client (104).

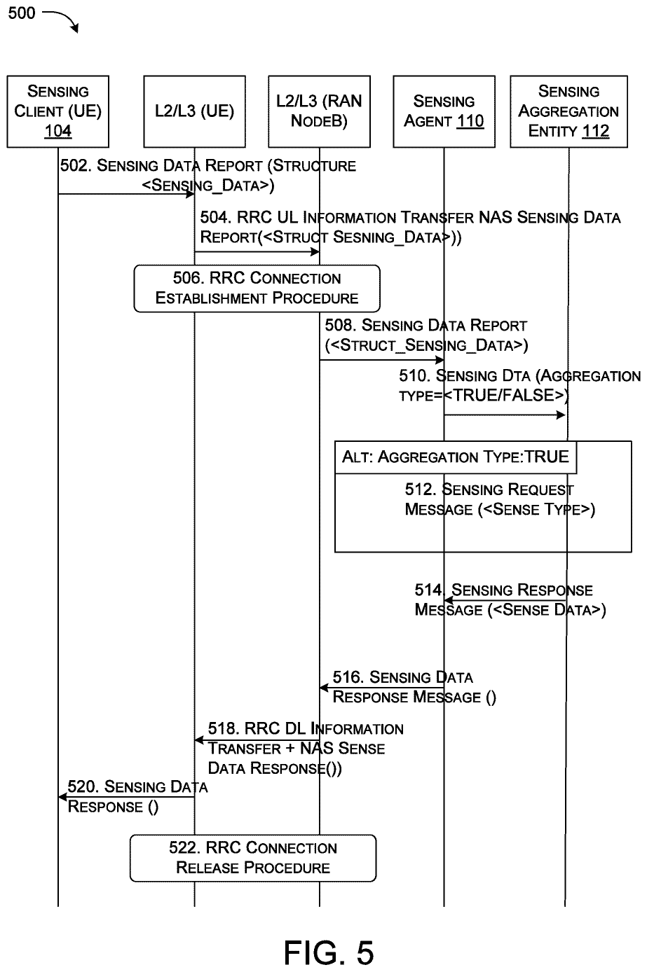

FIG. 5 illustrates an exemplary sequence diagram (500) for implementing a method for sharing sensing data in a cellular network, in accordance with an embodiment of the present disclosure.

In the proposed architecture, a RAN node (302) may have a first SA entity (112-1) associated therewith and the core network (304) may have a second SA entity (112-2) associated therewith.

In yet another embodiment, the UE (104) and the RAN node (302) may be coupled via a Radio Resource Control (RRC) connection or any of the Layer 2/3 protocol associated therewith. In an embodiment, the RRC may be suitably adapted to carry the sense/service request information. In an embodiment, the RRC or the L2/L3 layers associated therewith may process the message and send the request further to the sensing agents (110) or the SA entity (112) for a response.

In an embodiment, the UE (104) may establish the RRC connection in the RAN NodeB. In an embodiment, the connection may be established between the UE (104) and the RAN NodeB associated via the L2/L3 layers. In an embodiment, once the connection is established, the request message may be sent over RRC UL information along with a NAS container message from the L2/L3 layers in the UE (104) to the L2/L3 in the RAN node.

In an embodiment, the request message may be transmitted to the sensing agent (110). In an embodiment, the sensing agent (110) may collect the sensing data based on the request message and the one or more sensing types provided therewith. In an embodiment, the sensing data may be transmitted in the form of a data structure having a list of sensing data and associated one or more sensing types and the aggregration flags.

In an embodiment, the sensing agents (110) may collect the sensing data and forward the sensing report data to the SA entity (112) based on the value of the aggregation flag. In an example, if the aggregation flag is indicative of ‘TRUE,’ the sensing agent (110) may transmit the sensing data and the request message may be transmitted to the SA entity (112). In an embodiment, the SA entity (112) may request for more sensing data from different sensing agents (110) to collect the requested data and have an aggregated and meaningful value as per the service needs. In an embodiment, the aggregated response of the SA entity (112) may be transmitted back to the sensing client (e.g., UE) (104). In an embodiment, the SA entity (110) may transmit the aggregated response via the sensing agent (110) and the RAN node via the RRC connection to the sensing client (104).

With reference to FIG. 5, at 502, the sensing client (e.g., UE) (104) may establish a connection with the RAN NodeB. Upon successful establishment of the connection, the sensing client (e.g., UE) (104) may transmit a sensing data report to L2/L3 layers associated therewith.

At 504, the L2/L3 layers of the UE (104) may transmit the sensing data report to L2/L3 layers associated with the RAN NodeB.

At 506, the sensing client (e.g., UE) (104) may establish a RRC connection with the plurality of sensing agents (110) via the L2/L3 layers associated with the UE (104) and the RAN NodeB

At 508, the L2/L3 layers associated with the RAN NodeB may transmit the sensing data report to the sensing agents (110).

At 510, the method may determine a value of the aggregation type flag in the SA entity (112). Further, the sensing agents (110) may transmit the sensing data report to the SA entity (112) when the aggregation type flag indicating the aggregation is enabled, i.e., when the value of the aggregation type flag is “True”.

At 512, in response to determining that the aggregation type flag indicating the aggregation is enabled, the sensing agent (110) may transmit a data aggregation request message to the SA entity (112).

At 514, the SA entity (112) may receive the sensing data report from different sensing agents (110) and facilitate aggregation of the sensing data report received from the sensing agents (110) according to service requirements. Further, the SA entity (112) may transmit a response message to each of the sensing agents (110) in response to the aggregation of the sensing data report.

At 516, the sensing agents (110) may transmit the response message to the L2/L3 layers associated with the RAN NodeB.

At 518, the L2/L3 layers associated with the RAN NodeB may transmit the response message to the L2/L3 layers associated with the UE (104).

At 520, the L2/L3 layers associated with the UE (104) may transmit the response message to the UE (104).

At 522, in response to transmitting the response message to the UE (104), the RRC connection between the UE (104) and the sensing agents (110) may be released.

In an embodiment, the sensing data report may include the sensing type indicators indicating the type of data sensed by the sensors. In an embodiment, the sensing indicator may include, but not limited to a radio frequency (RF) imaging or a camera imaging. The sensing type indicator may also include a plurality of attributes, for example:
1. Signal Quality: Measures the quality of the received signal, including metrics such as signal-to-noise ratio (SNR), signal strength, and error rates.
2. CSI: Provides information about the characteristics of the wireless channel, such as fading, multipath propagation, and interference.
3. Beamforming: Involves parameters related to beamforming techniques, including beam direction, beamwidth, beam steering, and beamforming gain.
4. Interference Level: Quantifies the level of interference in the communication environment, which includes metrics such as interference power, interference-to-noise ratio (INR), and interference correlation.
5. Bandwidth Allocation: Determines the allocation of available bandwidth to different users or services, including parameters such as bandwidth utilization, allocation fairness, and quality of service (QOS) guarantees.
6. Doppler Shift: Represents the change in frequency of a signal due to the relative motion between transmitter and receiver, which is crucial for mobility and velocity estimation.
7. Carrier Frequency: Indicates the frequency at which the communication is taking place, which may vary depending on the specific frequency bands allocated for 6G systems.
8. Time Synchronization: Ensures that devices in the network are synchronized in time to facilitate coherent signal processing, and includes parameters such as time offset and clock drift.
9. Localization: Involves parameters related to precise positioning and location estimation of devices, which may include metrics like distance, angle of arrival (AoA), time of arrival (ToA), and received signal strength (RSS) for positioning.
10. Environmental Sensing: Includes parameters related to environmental conditions such as temperature, humidity, air quality, atmospheric pressure, and other relevant factors that may impact the communication performance.
11. Energy Efficiency: Measures the energy consumption and efficiency of devices and networks, including parameters such as power consumption, energy harvesting capabilities, and energy-saving techniques.
12. Security Parameters: Encompasses parameters related to ensuring the security and privacy of communications, including encryption, authentication, key management, and secure protocols.
13. Mobility Management: Includes parameters related to seamless handovers, user mobility patterns, velocity estimation, and trajectory prediction, which are essential for supporting high-speed mobile communications.
14. Latency and Delay: Quantifies the delay experienced by the transmitted signals, including parameters such as round-trip time (RTT), packet delay, and end-to-end latency, which are critical for ultra-responsive applications.
15. Traffic Load: Refers to the amount of traffic in the network, including parameters such as traffic volume, traffic density, and traffic patterns, which impact the overall system capacity and resource allocation.

It may be appreciated by those in the art that the sensing data detected by the sensing agent (110) may be suitably adapted based on the requirements. Further, the request message from the UE (104) may indicate the request to collect any one or combination of the aforementioned parameters.

In an embodiment, the system (108) may be configured to produce and transmit System Information Blocks (SIB) and Master Information Block (MIB) messages to the UE (104). In such embodiments, the sensing capabilities associated with the sensing agents (110) may be published to indicate the sensing types of the sensing data that may be collected by the sensing agents (110). In an example, the system (108) may broadcast whether the RAN nodes host cameras on the tower, any possible RF imaging capability on the tower, etc.

In an embodiment, the system (108) or elements therein may be triggered to sense measurements by either the first sensing client by the sensing agent (110) at the core network/application layer (304). In other embodiments, the SA entity (112) may be triggered periodically or based on a predefined event to collect the sensing data through the sensing agents (110).

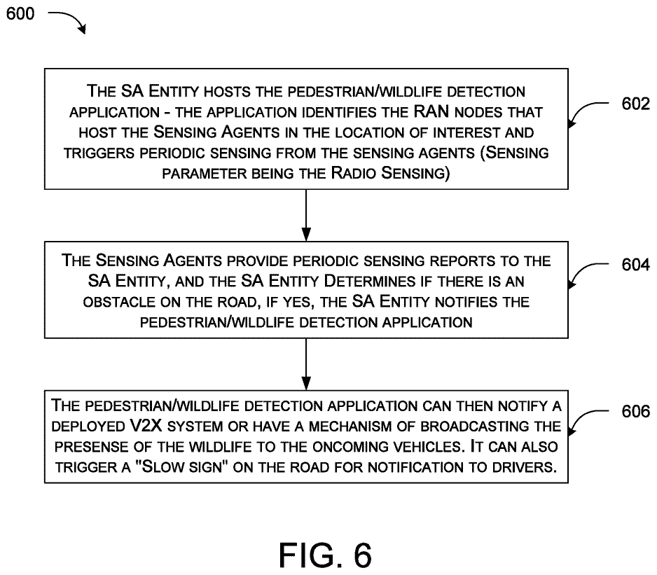

FIG. 6 illustrates an example flowchart (600) illustrating a scenario for sensing objects at a pedestrian crossing, in accordance with the embodiments of the present disclosure.

Considering an example, when the proposed system (108) is deployed for sensing pedestrian crossing on the road or the presence of wildlife on the road. In such examples, at step 602, the SA entity (112) may host a pedestrian/wildlife detection application, where the application identifies the RAN nodes that host the sensing agents (110) in a location of interest and triggers periodic sensing from the sensing agents (110) (sensing parameter being the radio sensing). At step 604, the sensing agents (110) may provide periodic sensing reports to the SA entity (112), and the SA entity (112) may determine if there is an obstacle on the road. If yes, the SA entity (112) may notify the pedestrian/wildlife detection application. At step 606, the pedestrian/wildlife detection application may then notify a deployed V2X system or have a mechanism of broadcasting the presence of the wildlife to the vehicles. The method may also include triggering a “Slow sign” on the road for notifying the drivers.

### Exemplary Scenarios

In an embodiment, the system (108) may enhance a performance of the network (106) by providing optimization input for network steering. In an example, the sensing agent (110) may be able to detect objects that (temporarily) obstruct the direct propagation path between a transmission node and the UE (104). This input may be used for rapid beam steering such that the system (108) may utilize a reflected beam or switch to a different transmission point for communication with the UE (104).

In an embodiment, the system (108) may also provide outdoor spatial sensing as a service to users outside the network (106). For instance, depending on the frequency, the resolution of the sensing image that may be obtained varies. For frequencies around 100 GHz and their typical bandwidths, it may be possible to reach resolutions below 1 cm. However, the resolution also depends on the reflective properties of an object as well as the proximity to other nearby objects and their reflective properties. In comparison to a visual image from a camera, a sensing image based on the reflections from the transmitted signals may be quite crude. However, this sensing method offers other attractive properties that the camera may not provide.

By measuring the delay of the return echo in the line-of-sight path between the transmitter and the object, the distance to the object may be calculated, and therefore, its position may be determined. Similarly, by measuring the Doppler shift in the received echo, compared to the transmitted signal, the velocity of the measured object may be calculated. Another useful feature of sensing based on radio signals is its applicability in situations involving low visibility. The system (108) may be able to sense or ‘see’ in rain or fog, since the water particles in the air may attenuate the signals, especially at higher frequencies.

In other embodiments, the system (108) may be used for monitoring traffic where the sensing data may include, but not be limited to, measurements associated with position and speed of moving objects. For example, the system (108) may include two or three Transmit/Receive (Tx/Rx) nodes overlooking an urban street intersection. In such examples, the system (108) may provide a useful set-up for analysis of the interplay between communication and sensing parameter choices.

In yet other embodiments, the system (108) may be used for indoor sensing in manufacturing facilities. In such embodiments, the precise position estimation around a factory robot may help to determine where a robot arm is located and if there are any interfering objects, such as a human, inside its intended space of motion. In an example, the system (108) may be configured to sense the position estimation of objects that a robot may grip, or of objects that the robot has released.

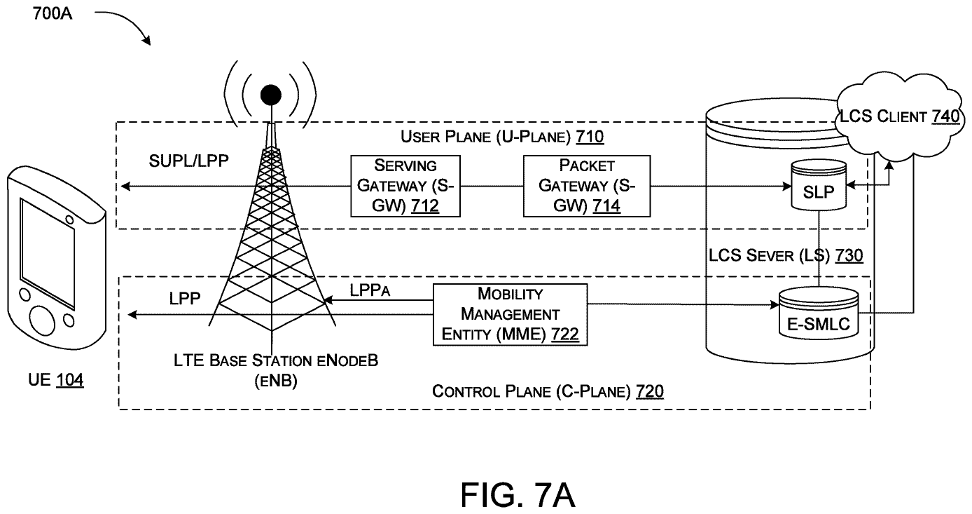

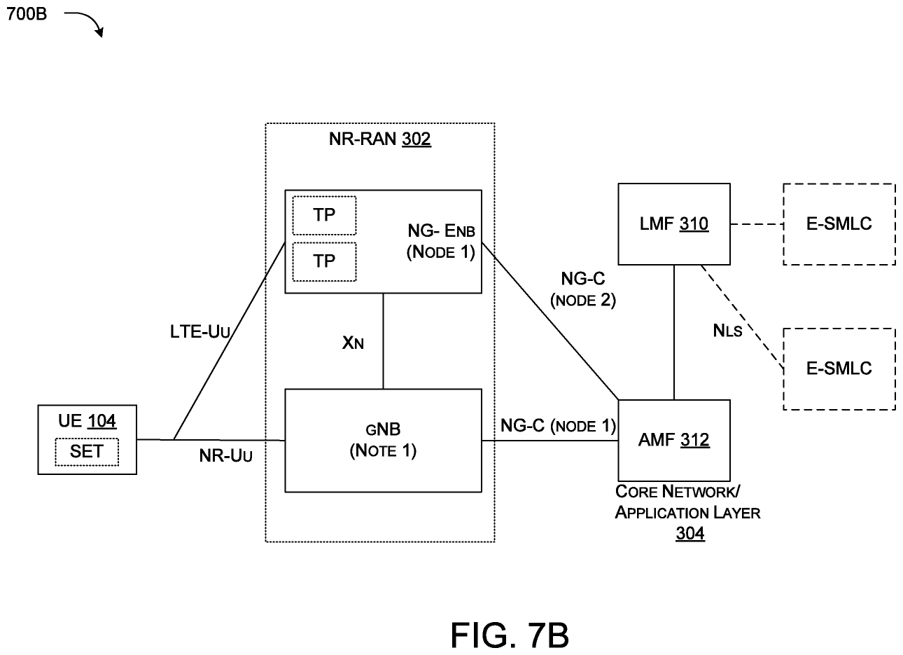

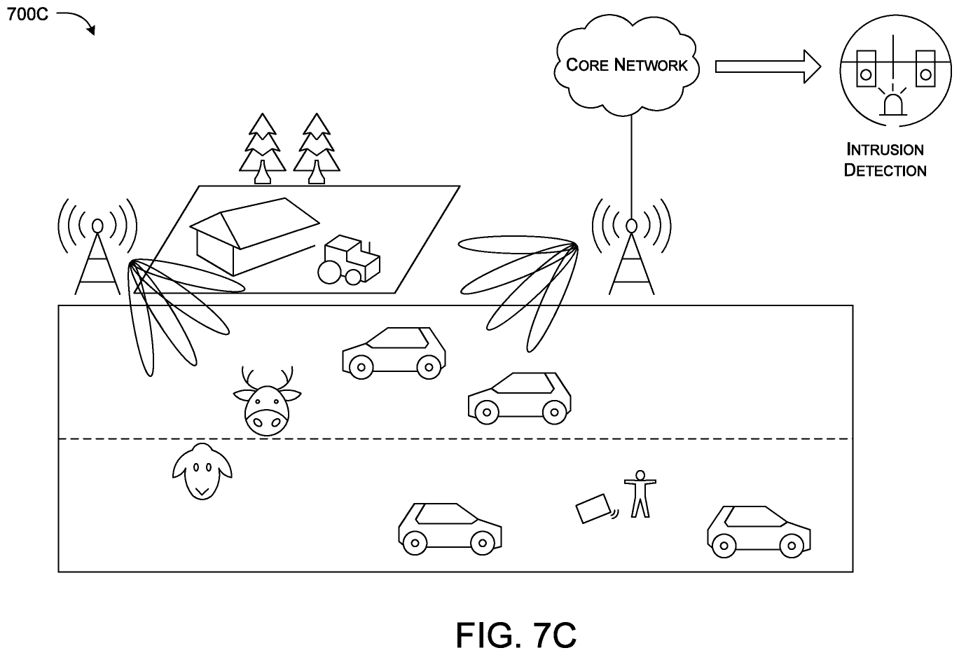

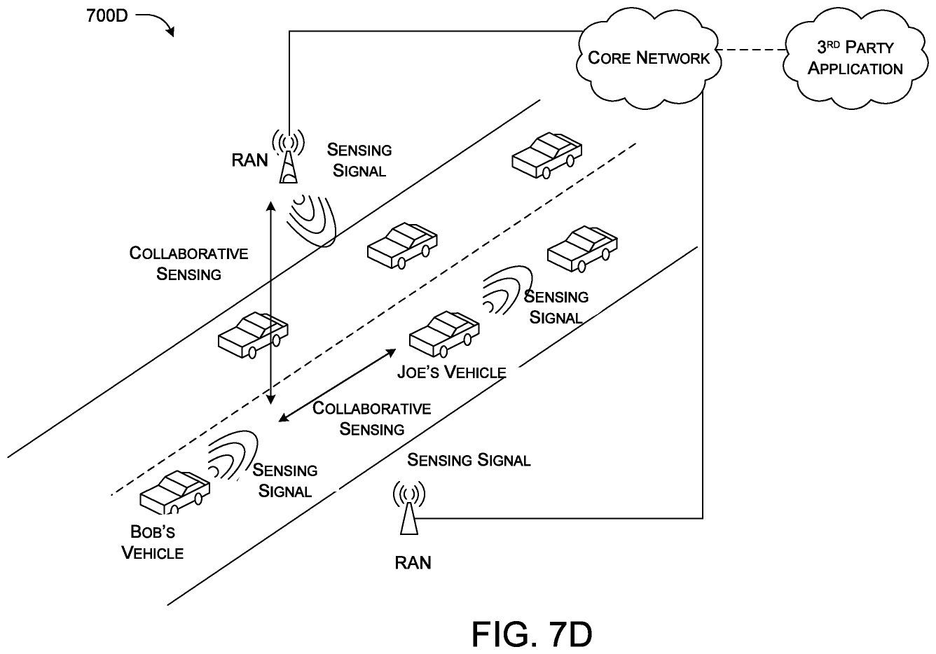

FIGS. 7A-7D illustrate exemplary applications (700A-700D) of the proposed system (108), in accordance with embodiments of the present disclosure.

FIG. 7A illustrates an existing location services architecture which may be suitably adapted to create the system (108), e.g., an integrated communication and sensing system.

In an example, a Location Positioning Protocol (LPP) may be a point-to-point protocol that allows multiple connections to different devices. The LPP may be used in both user plane (710) and control plane (720), for example, a Long-Term Evolution (LTE). In an embodiment, the user plane (710) may include a serving gateway (S-GW) (712) and a packet gateway (P-GW) (714). In an embodiment, the control plane (720) may include a mobility management entity (722). The exchanged LPP messages and information may be divided into any one or more of a UE positioning capability information transfer to an E-SMLC, positioning assistance data delivery from the E-SMLC to the UE (104), location information transfer, and session management-error handling and abort functions, and the like. In an embodiment, the system (108) may include a Location Service (LCS) server (730) having the E-SMLC and SLP communicatively coupled to an LCS client (740).

In an embodiment, the LPP may provide support for Global Navigation Satellite System (GNSS) based positioning, network-based positioning, and hybrid—a combination of both GNSS and network-based positioning. The LPP may be a relatively simple protocol with support for reliable in sequence transmission of data. The LPP may include support for acknowledged mode information exchange, thereby preventing reordering of messages due to the use of ‘stop-and-wait’ transmissions to ensure that messages arrive in the correct order of transmission. When LPP is used over the user plane (U-plane (710)) via a Secure User Plane Location (SUPL), the acknowledgment information may be omitted and replaced by a Transmission Control Protocol/Internet Protocol (TCP/IP protocol).

SUPL is an encrypted Internet Protocol (IP) technology that supports Location-Based Services (LBS) for wireless communications. SUPL may be bearer agnostic and may be applied to multiple wireless standards including LTE, where SUPL 2.0 may be used for U-plane LBS sessions. The U-plane message exchange takes place in connected stated over the IP data link of the mobile communication standard. SUPL 2.0 may define a set of protocols for transporting existing messages as defined by the wireless standards including, but not limited to, Global System for Mobile (GSM) communication, (Radio Resource Location Protocol, RRLP), Wideband Code Division Multiple Access (WCDMA) (Radio Resource Control, RRC), Code-Division Multiple Access (CDMA) (Telecommunications Industry Association-801, TIA-801), and LTE (LTE Positioning Protocol, LPP). The adoption of SUPL 2.0 offers significant advantages for LTE LBS deployment by granting operators with greater flexibility. Notably, it enables the seamless implementation of LTE LBS using established RRLP protocols (instead of LPP) over the SUPL 2.0 framework. This approach minimizes the necessary modifications to both the device and network components, thereby streamlining the implementation process.

FIG. 7B illustrates an exemplary block diagram (700B) of the proposed system (108), in accordance with embodiments of the present disclosure.

In an embodiment, to improve the performance of 5G NR, new positioning reference signals (PRS) and a new LMF (310) (as illustrated in FIG. 3A) may be added to the system's specification.

In an embodiment, the LMF (310) may receive measurements and assistance information from the RAN node (302) and the UE (104), via the AMF (312) over the NLs interface to compute the position of the UE (104). In an embodiment, a new NR positioning protocol A (NRPPa) may be used to carry the positioning information between the RAN (302) and the LMF (310) over the next generation control plane interface (NG-C) for compatibility with next generation interface between the RAN (302) and the core network (304). In such embodiments, the additions in the 5G architecture may provide the framework for positioning in 5G. In an embodiment, the LMF (310) may be configured to the UE (104) using the LPP via the AMF (312). The RAN (302) may be configured to the UE (104) using the RRC protocol over LTE-Uu and NR-Uu interfaces.

In the present disclosure, the necessary architectural enhancements and interfaces to the existing location-based services architecture to accommodate sensing inputs may be provided. In an embodiment, an Integrated Sensing and Communication (ISAC) service may have various use cases, which may be classified into two main categories: outdoor and indoor. In an embodiment, the outdoor use cases may be related to smart transportation, while the indoor use cases may be related to smart life.

In an embodiment as shown in FIG. 7C, the outdoor use cases may include the perception of blind spots in road traffic areas. In such embodiments, the lack of early warning may be the main cause of accidents. A 5G-Advanced ISAC may be proposed with use of integrated communication and sensing system (108). This solution supports sensing of objects with or without communication modules, and thus may minimize the traffic accident rate. Additionally, the system (108) may offer real-time warnings, which is critical in such use cases.

In another embodiment, as shown in FIG. 7D, the outdoor use case may include the perception of road dynamic information. In such embodiments, the system (108) may be used for perception-assisted traffic condition detection, thereby overcoming the limitations of existing solutions. The system (108) may offer a larger deployment coverage without additional cost and may have the potential to solve most issues related to traffic congestion and traffic safety risk detection with real-time and high accuracy.

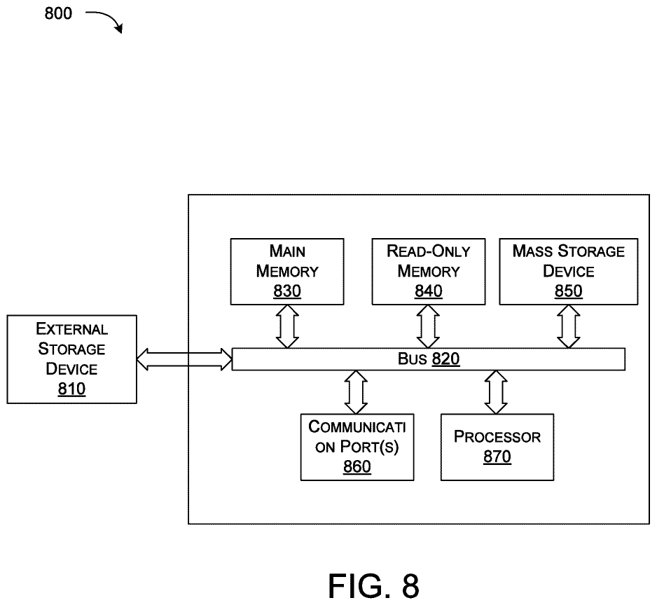

FIG. 8 illustrates an exemplary computer system (800) in which or with which embodiments of the present disclosure can be utilized, in accordance with embodiments of the present disclosure.

For example, the integrated communication and sensing system (108 of FIGS. 1 and 2) may be implemented as the computer system (800). Alternatively, or additionally, the SA entity may be implemented as the computer system (800).

As shown in FIG. 8, the computer system (800) may include an external storage device (810), a bus (820), a main memory (830), a read-only memory (840), a mass storage device (850), communication port(s) (860), and a processor (870). A person skilled in the art will appreciate that the computer system (800) may include more than one processor and communication ports. The communication port(s) (860) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (860) may be chosen depending on a network, such a Local Area Network (LAN), Wide Area Network (WAN), or any network to which the computer system (800) connects. The main memory (830) may be a random-access memory (RAM), or any other dynamic storage device commonly known in the art. The read-only memory (840) may be any static storage device(s) including, but not limited to, Programmable Read Only Memory (PROM) chips for storing static information e.g., start-up or basic input/output system (BIOS) instructions for the processor (870). The mass storage device (850) may be any current or future mass storage solution, which may be used to store information and/or instructions.

The bus (820) communicatively couples the processor (870) with the other memory, storage, and communication blocks. The bus (820) can be, e.g. a Peripheral Component Interconnect (PCI)/PCI Extended (PCI-X) bus, a Small Computer System Interface (SCSI), a universal serial bus (USB), or the like, for connecting expansion cards, drives, and other subsystems as well as other buses, such a front side bus (FSB), which connects the processor (870) to the computer system (800).

Optionally, operator and administrative interfaces, e.g. a display, keyboard, and a cursor control device, may also be coupled to the bus (820) to support direct operator interaction with the computer system (800). Other operator and administrative interfaces may be provided through network connections connected through the communication port(s) (860). In no way should the aforementioned exemplary computer system (800) limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE PRESENT DISCLOSURE

The present disclosure provides an integrated communication and sensing network architecture.

The present disclosure provides an integrated communication and sensing network architecture with improved performance.

The present disclosure provides an integrated communication and sensing network architecture with outdoor spatial sensing as a service to users external to a network.

The present disclosure provides an integrated communication and sensing network architecture with indoor sensing for applications including, but not limited to, manufacturing facilities.

The present disclosure provides an integrated communication and sensing network architecture with sensing to aid simulations of digital twins of structures.

The present disclosure provides an integrated communication and sensing network architecture for one or more automation related aspects.

The present disclosure provides a remote sensing network architecture.

The present disclosure provides an integrated communication and sensing network architecture using an optimized power assembly.

We claim:

1. A system (108) for sharing sensing data in a cellular network (106), the system (108) comprising:
a processor (202); and
a memory (204) operatively coupled with the processor (202), wherein said memory (204) stores instructions which, when executed by the processor (202), cause the processor (202) to:
establish a Radio Resource Control (RRC) connection between one or more sensing clients (104) and a plurality of sensing agents (110);
upon successful establishment of the RRC connection, determine that an aggregation type flag indicating an aggregation is enabled in a sensing aggregation entity (112) associated with the system (108);
enable the sensing aggregation entity (112) to receive a sensing data report from each of the plurality of sensing agents (110) based on the determination, wherein each of the plurality of sensing agents (110) receives the sensing data report from the one or more sensing clients (104);
facilitate aggregation of the sensing data report received from each of the plurality of sensing agents (110) in the sensing aggregation entity (112) according to service requirements; and
transmit a response message to the one or more sensing clients (104) in response to the aggregation of the sensing data report.

2. The system (108) as claimed in claim 1, wherein the processor (202) is to receive the sensing data report from each of the plurality of sensing agents (110), and transmit the response message to the one or more sensing clients (104) as at least one message, wherein the at least one message is one of: a Non-Access Stratum (NAS) message or a broadcast message.

3. The system (108) as claimed in claim 1, wherein the sensing data report comprises a plurality of attributes, wherein plurality of attributes comprises at least one of: a target location, a direction indication, a signal quality, Channel State Information (CSI), beamforming parameters, an interference level, bandwidth allocation, a Doppler shift, a carrier frequency, time synchronization, environmental sensing parameters, energy efficiency, security parameters, mobility management, latency and delay, and a traffic load.

4. The system (108) as claimed in claim 1, wherein the processor (202) is to enable each of the plurality of sensing agents (110) to receive the sensing data report from the one or more sensing clients (104) upon structuring the sensing data report according to a predefined list of sensing data. pcm 5. The system (108) as claimed in claim 1, wherein the processor (202) is to enable the sensing aggregation entity (112) to receive the sensing data report from each of the plurality of sensing agents (110) by being configured to receive a data aggregation request from each of the plurality of sensing agents (110).

6. The system (108) as claimed in claim 1, wherein in response to transmitting the response message to the one or more sensing clients (104), the processor (202) is to release the RRC connection between the one or more sensing clients (104) and the plurality of sensing agents (110).

7. A method for sharing sensing data in a cellular network (106), the method comprising:
establishing, by a processor (202) associated with a system (108), a Radio Resource Control (RRC) connection between one or more sensing clients (104) and a plurality of sensing agents (110);
upon successful establishment of the RRC connection, determining, by the processor (202), that an aggregation type flag indicating an aggregation is enabled in a sensing aggregation entity (112) associated with the system (108);
enabling, by the processor (202), the sensing aggregation entity (112) to receive a sensing data report from each of the plurality of sensing agents (110) based on the determination, wherein each of the plurality of sensing agents (110) receives the sensing data report from the one or more sensing clients (104);
facilitating, by the processor (202), aggregation of the sensing data report received from each of the plurality of sensing agents (110) in the sensing aggregation entity (112) according to service requirements; and
transmitting, by the processor (202), a response message to the one or more sensing clients (104) in response to the aggregation of the sensing data report.

8. The method as claimed in claim 7, comprising receiving, by the processor (202), the sensing data report from each of the plurality of sensing agents (110), and transmitting, by the processor (202), the response message to the one or more sensing clients (104) as at least one message, wherein the at least one message is one of: a Non-Access Stratum (NAS) message or a broadcast message.

9. The method as claimed in claim 7, wherein the sensing data report comprises a plurality of attributes, wherein plurality of attributes comprises at least one of: a target location, a direction indication, a signal quality, Channel State Information (CSI), beamforming parameters, an interference level, bandwidth allocation, a Doppler shift, a carrier frequency, time synchronization, environmental sensing parameters, energy efficiency, security parameters, mobility management, latency and delay, and a traffic load.

10. The method as claimed in claim 7, comprising enabling, by the processor (202), each of the plurality of sensing agents (110) to receive the sensing data report from the one or more sensing clients (104) upon structuring the sensing data report according to a predefined list of sensing data.

11. The method as claimed in claim 7, wherein enabling, by the processor (202), the sensing aggregation entity (112) to receive the sensing data report from each of the plurality of sensing agents (110) comprises receiving, by the processor (202), a data aggregation request from each of the plurality of sensing agents (110).

12. The method as claimed in claim 7, wherein in response to transmitting the response message to the one or more sensing clients (104), the method comprises releasing, by the processor (202), the RRC connection between the one or more sensing clients (104) and the plurality of sensing agents (110).

13. A user equipment (UE) (104), comprising:
a processor; and
a memory operatively coupled to the processor, wherein the memory comprises processor-executable instructions, which on execution, cause the processor to:
establish a Radio Resource Control (RRC) connection with a plurality of sensing agents (110) associated with a system (108), and
upon successful establishment of the RRC connection, transmit a sensing data report to each of the plurality of sensing agents (110),
wherein the processor is communicatively coupled with the system (108), and wherein the system (108) is configured to:
determine that an aggregation type flag indicating an aggregation is enabled in a sensing aggregation entity (112) associated with the system (108);
enable the sensing aggregation entity (112) to receive the sensing data report from each of the plurality of sensing agents (110) based on the determination;
facilitate aggregation of the sensing data report received from each of the plurality of sensing agents (110) in the sensing aggregation entity (112) according to service requirements; and
transmit a response message to the UE in response to the aggregation of the sensing data report.

14. A non-transitory computer-readable medium comprising processor (202)-executable instructions that cause a processor (202) to:
establish a Radio Resource Control (RRC) connection between one or more sensing clients (104) and a plurality of sensing agents (110);
upon successful establishment of the RRC connection, determine that an aggregation type flag indicating an aggregation is enabled in a sensing aggregation entity (112) associated with the system (108);
enable the sensing aggregation entity (112) to receive a sensing data report from each of the plurality of sensing agents (110) based on the determination, wherein each of the plurality of sensing agents (110) receives the sensing data report from the one or more sensing clients (104);
facilitate aggregation of the sensing data report received from each of the plurality of sensing agents (110) in the sensing aggregation entity (112) according to service requirements; and
transmit a response message to the one or more sensing clients (104) in response to the aggregation of the sensing data report.
